(19) United States
(12) Patent Application Publication
(10) Pub. No.: US 2016/0105274 A1
(43) Pub. Date: Apr. 14, 2016

(54) WIRELESS NETWORK THROUGHPUT SYSTEM AND METHOD

(71) Applicant: GAIN ICs LLC, Peyton, CO (US)

(72) Inventor: Jed Griffin, Peyton, CO (US)

(21) Appl. No.: 14/514,286

(22) Filed: Oct. 14, 2014

(51) Int. Cl. H04L 7/00; H04L 27/227; H04B 1/54

(52) U.S. Cl. CPC H04L 7/0087; H04B 1/54; H04L 27/2271

(57) ABSTRACT

Wireless network throughput system and method implementing ultra phase modulation (UPM). An example system includes a receiver, a transmitter, UPM modulator, UPM demodulator and an ultra-phase coordinator (UPC) circuit connected to the receiver and to the transmitter antennae. The UPM wireless network throughput system and method reduces RF reception to only amplifying, filtering, and demodulating without any down-conversion. In an example, the system includes a frequency memory, wherein a frequency of a signal received at the receiver is recorded and a same frequency is used to transmit a signal in return.

### RELATED APPLICATION

This application is related to co-owned U.S. patent application Ser. No. 13/758,915 titled “Phase Coordinating Systems and Methods” of Jed Griffin, filed on Feb. 4, 2013 and hereby incorporated herein by reference in its entirety as though fully set forth herein.

### BACKGROUND

Overcrowding of the wireless radio frequency (RF) spectrum leads to more interference and/or unintentional jamming between communication channels. The problem exists within military and commercial communications bands, and has caused jam-ups and delays that hamper the ability to maintain adequate communications via wireless devices.

Current RF (generally referred to as “wireless”) technology has inherent limitations which hamper data transfer rates, throughput, and occupies significant bandwidth. These impediments are intrinsic to the complex design of the quadrature (or “superheterodyne”) architecture. Despite these limitations, the quadrature architecture is used almost exclusively in today's commercial and military wireless communication devices.

Software (or “digital”) demodulation may also be implemented, wherein digital signal processing (DSP) enables a so called software radio. However, DSP demodulation is inhibited by the same problems as software demodulation via DSP in quadrature architectures, including poor receiver sensitivity, long latency, compromised lower throughput, poor link spectral efficiencies, very long time to transition to new frequencies (turn-around time), and excessive power consumption.

Wireless hardware targeting according to the IEEE 802.11n specification did not realize the full projected data rate or throughput, due to the power required by the DSP to decipher the signal. In a similar manner, the newer IEEE 802.11ac specification adds even more complexity for the DSP to decipher.

### BRIEF DESCRIPTION OF THE DRAWINGS

FIG. 1 is a diagram of an integrated circuit which may implement a wireless network throughput system and method.

FIG. 1A is a detailed diagram of an example UPC circuit of FIG. 1

FIG. 1B is an illustration of high loop gain realized by an example UPC circuit.

FIG. 1C shows output illustrating a comparison of traditional PLL tracking and UPC tracking.

FIG. 1D is a detailed diagram of an example modulator circuit of FIG. 1.

FIG. 1E is a detailed diagram of an example demodulator circuit of FIG. 1.

FIG. 1F is a detailed diagram of an example synch circuit of FIG. 1.

FIG. 2 is a high-level illustration of increasing bandwidth to achieve greater throughput.

FIGS. 3A-B are high-level illustrations showing how the wireless network throughput system and method eliminate interference of traditional RF communications, wherein A) shows narrower occupied bandwidth and frequency hopping spread spectrum, and B) shows no spread spectrum.

FIGS. 4A-B are high-level illustrations showing narrowband versus broadband, wherein A) shows narrower occupied bandwidth and a frequency hopping spread spectrum, and B) shows a direct-sequence spread spectrum.

FIGS. 5A-B are plots showing how the wireless network throughput system and method eliminate down convert.

FIG. 6 is a high-level illustration showing how the wireless network throughput system and method eliminate dominant noise and complexity of quadrature modulation.

FIGS. 7A-B show example noise comparisons and FIG. 7C shows example antennae dimensions.

FIG. 8 shows output illustrating high link spectral efficiency, throughput, and faster acquisition time of the wireless network throughput system and method.

FIG. 9 is a plot of bit error rate (BER) and signal to noise ratio (SNR) of modulation methods.

FIGS. 10A-B are plots illustrating transmission distance increase using the wireless network throughput system and method.

### DETAILED DESCRIPTION

The IEEE 802.11ac specification, a quadrature amplitude modulation (QAM), proposes a higher data rate than previous QAM via a denser constellation, but makes a number of concessions for the limitations brought on by the quadrature architecture. These concessions include, but are not limited to the need for wider occupied bandwidth per channel; IEEE 802.11n was at 80 MHz while it's replacement, IEEE 802.11ac is 160 MHz; the need for three transmitting channels, tuned antenna and power stage for each channel; the need for higher transmission power and a reduced noise floor, to accommodate the poor required signal to noise ratio (SNR) of the receiver; beam forming to “steer” the signal to the receiver; and software to coordinate the use of the aforementioned which adds complexity, delays, longer turn-around times, and potential for failure.

A wireless network throughput system and method is disclosed herein and may be implemented in circuitry (e.g., an integrated circuit or IC). In an example, a wireless network (e.g., WiFi) throughput system includes a receiver, a transmitter, and an ultra-phase coordinator (UPC) circuit connected to the receiver and to the transmitter. The UPC circuit reduces modulation to only amplifying, filtering, and demodulating without any down-conversion.

In an example, the wireless network throughput system and method includes a narrowband amplifier (NBA) connected between the receiver and the UPC circuit.

In an example, the wireless network throughput system and method includes a frequency memory, wherein a frequency of a signal Rx received at the receiver is recorded and a same frequency is used to transmit a signal Tx.

In an example, the UPC circuit comprises a phase locator (PL) circuit and controlled oscillator (CO) circuit, or a voltage controlled oscillator (VCO).

In an example, the wireless network throughput system and method includes a modulator connected to the UPC circuit. The modulator receives an output data stream from a microcontroller or other on-die circuitry.

In an example, the wireless network throughput system and method includes a demodulator connected to the UPC circuit. The demodulator includes a wideband amplifier (WBA), and synchronization circuit. The demodulator demodulates signals from UPC to create an input data stream with a synchronizing clock signal.

The wireless network throughput system and method may reduce the size, weight and power (SWaP) envelope of a radio device (e.g., a handheld device) by reducing power and system integration on a chip. The chip has a lower power consumption, and smaller size and weight of the power source (e.g., battery pack per a fixed battery run time), relative to the quadrature architecture.

The wireless network throughput system and method eliminates about one tenth of the circuitry associated with the quadrature architecture. As such, the wireless network throughput system and method consumes about one tenth of the power used in quadrature architecture. By increasing data rates and reducing transition and startup times (e.g., to near real time), the circuit of the wireless network throughput system and method is powered on for less time than the quadrature architecture circuit, thus also reducing average power consumption over time.

Another salient power reduction in the wireless network throughput system and method is realized by greatly increasing the receiver sensitivity via ultra phase modulation (UPM). It is noted that the term “UPM” as used herein refers to a wireless network throughput system and method wherein modulation and/or demodulation accomplished by using a UPC circuit (or other similar fast phase coordinating circuit). Relative to the quadrature architecture (which has a poor signal to noise ratio (SNR), excessive transmitted power used for UPM is not needed to overcome a high noise levels.

Before continuing, it is noted that as used herein, the terms “includes” and “including” mean, but is not limited to, “includes” or “including” and “includes at least” or “including at least.” The term “based on” means “based on” and “based at least in part on.”

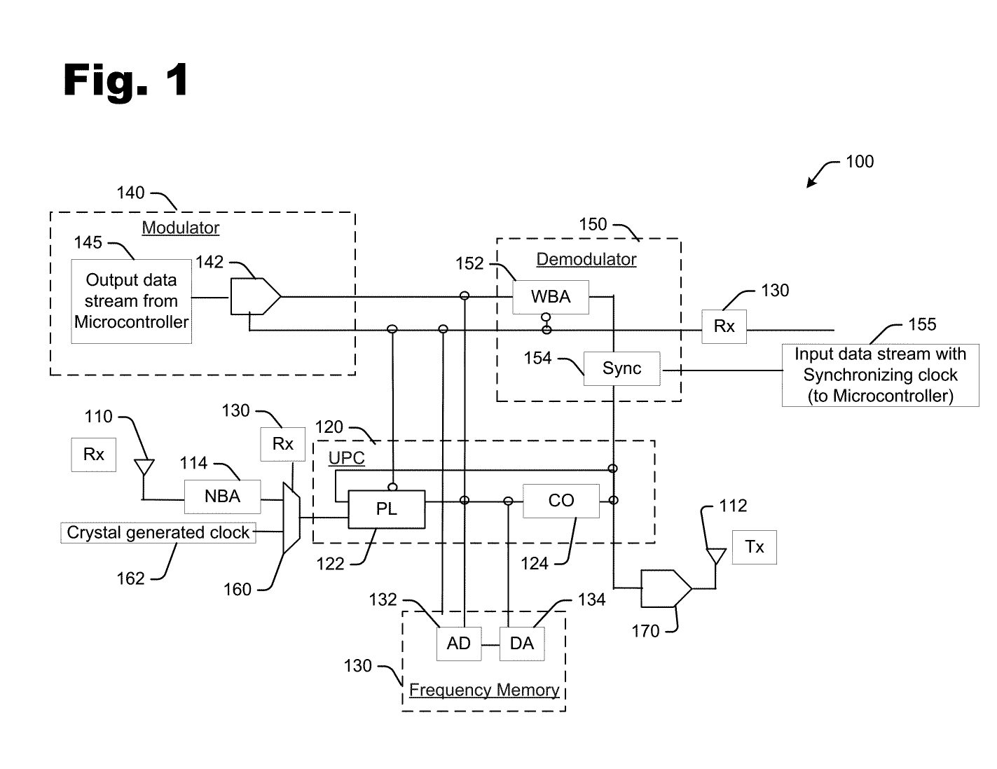

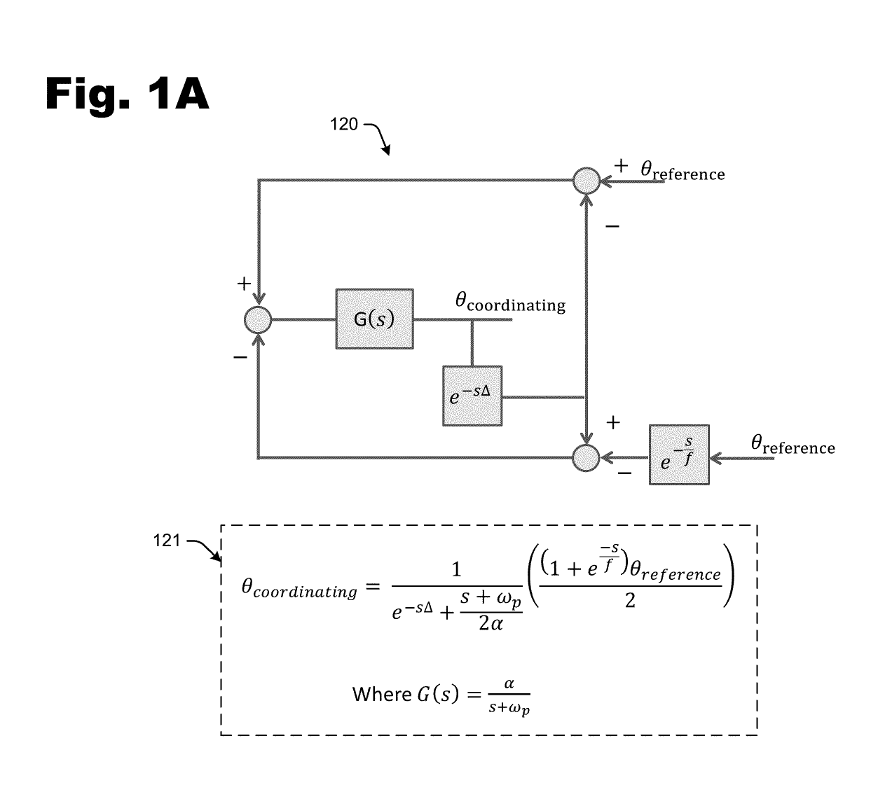

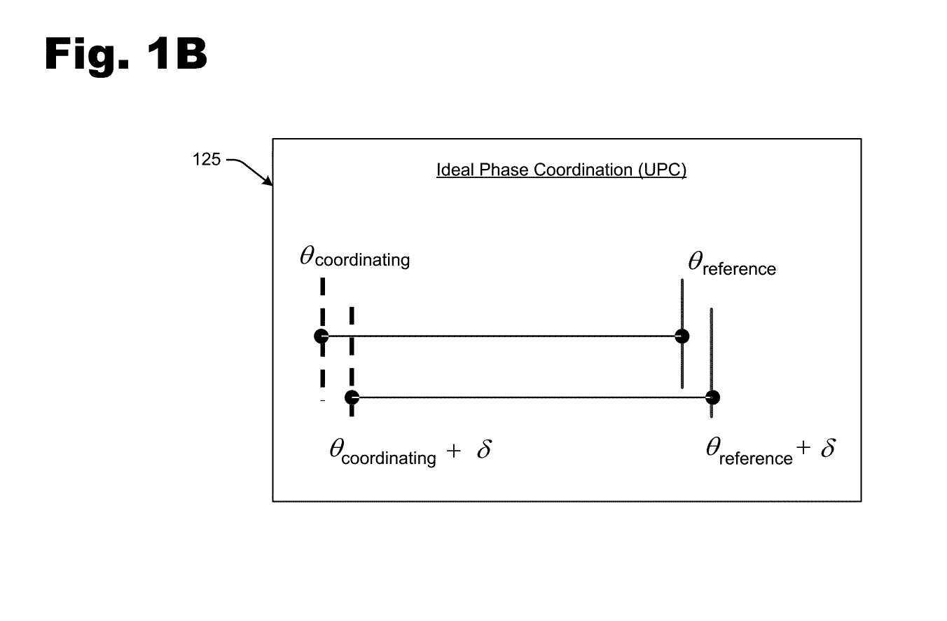

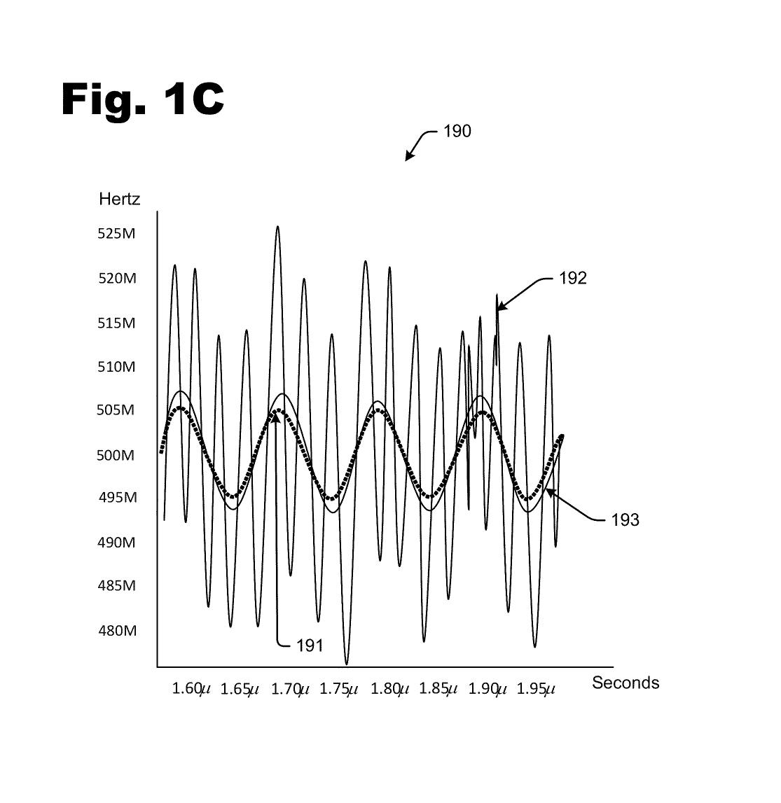

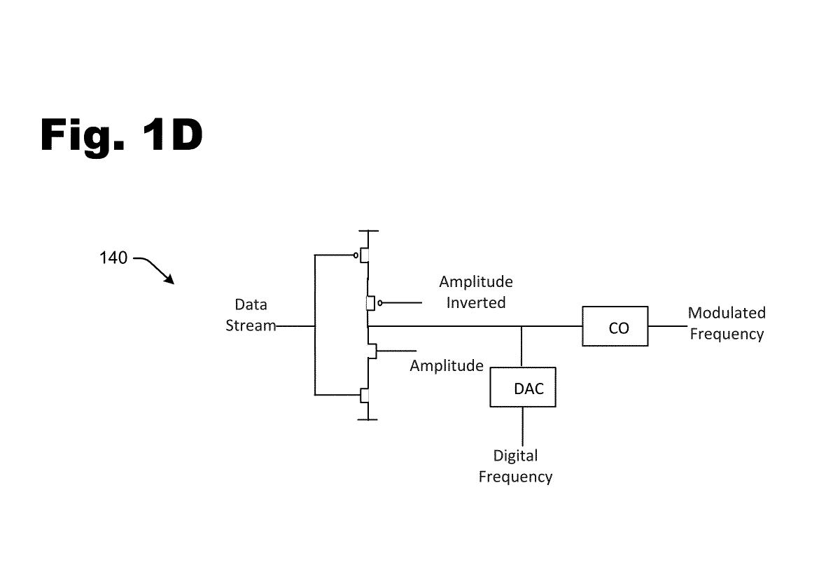

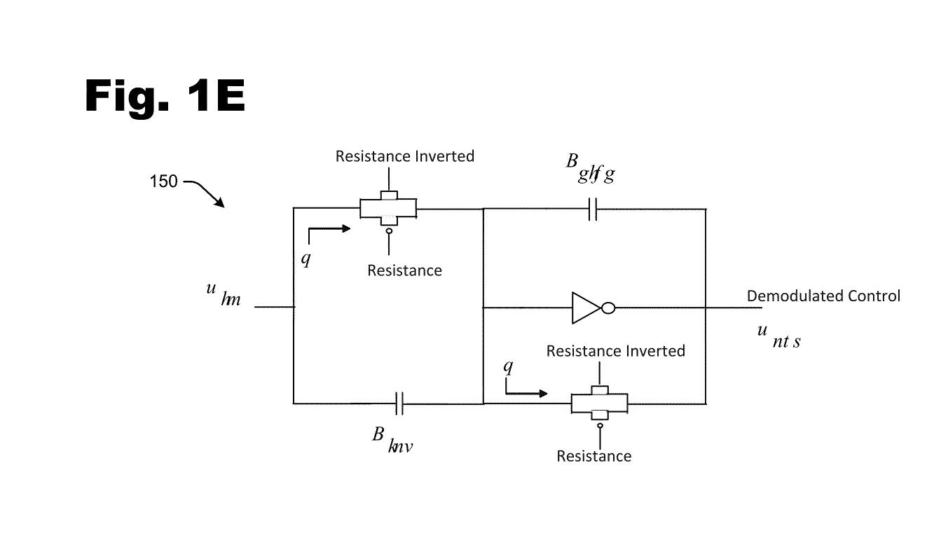

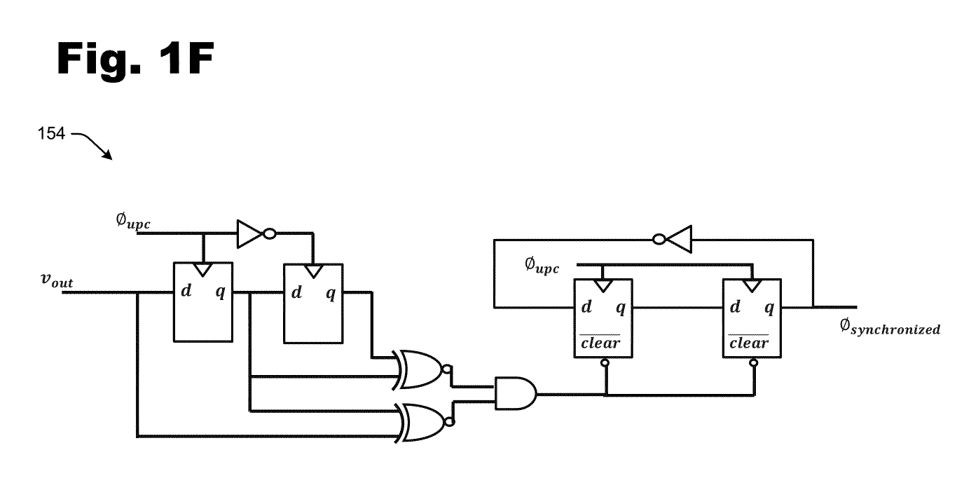

FIG. 1 is a diagram of an integrated circuit (IC) 100 which may implement a wireless network throughput system and method. In an example, the IC 100 may be a wireless network (e.g., WiFi) throughput system. However, the wireless network throughput system and method is not limited to use with any specific wireless communications network. Nor is implementation of the wireless network throughput system and method limited to an integrated circuit.

In an example, the IC 100 includes a receiver antenna 110, a transmitter antenna (which may be the same as the receiver antenna) 112, and an ultra-phase coordinator (UPC) circuit 120 connected to the receiver antenna 110 and to the transmitter antenna 112. The UPC circuit 120 reduces deciphering or demodulation to only amplifying, filtering, and demodulating without any down-conversion. In an example, the IC 100 includes a narrowband amplifier (NBA) 114 connected between the receiver antenna 110 and the UPC circuit 120. In an example, the UPC circuit 120 includes a phase locator (PL) circuit 122 and a controlled oscillator (CO) circuit 124.

FIG. 1A is a detailed diagram of an example UPC circuit 120 of FIG. 1. Calculation of the coordinating signal is illustrated at 121. The Laplace transform block diagram 120 shows all loop elements for UPC, the lumped gain G from CO gain and PL gain, as well as phase shifted output and one cycle phase shifted reference. From equation 121, derived from 120, the key capability of UPC can be observed, that there is a new ideal phase coordination between the reference phase and coordinating phase. It is appreciated that other near ideal phase tracking circuits could possibly be implemented other than UPC to achieve similar characteristics key to operating per the modulation scheme defined herein.

FIG. 1B is an illustration of high loop gain 125 realized by an example UPC circuit 120 or any other “ideal” (or near ideal) PLL circuit. Denoted by this graph is that whenever and at whatever speed the reference shifts by δ the coordinating phase shifts by exactly the same magnitude and at the same speed. Similar phase tracking circuits could possibly achieve this ideal phase coordinating performance as well. FIG. 1C shows output illustrating a comparison of traditional PLL tracking and UPC coordinating. The plot 190 in FIG. 1C shows a clock signal 191, and the pronounced jitter peaking 192 found with traditional PLL tracking. The plot 190 in FIG. 1C shows a signal 193 for a UPC circuit set at the same high loop gain as a traditional PLL exhibits no jitter peaking, and has exact (or nearly the same) coordination with the reference signal 191.

An ideal phase lock loop (referred to herein as ultra phase coordination (UPC)) is created by the two blocks PL and CO, which coordinates a new coordinating phase to the modulated phases from the receiver antenna at very high rates of deviation. As such, UPC enables hardware demodulation at the very high transmit frequencies for very high throughput, using frequency shift keying (FSK). This significantly reduces or even fully eliminates all of the pronounced and inherent limitations and noise sources of down conversion seen in quadrature architectures, and enables the device disclosed herein to perform hardware-only demodulation.

In an example, the IC 100 may also include a frequency memory 130. The frequency memory 130 may include an analog to digital converter (ADC) 132 and a digital to analog converter (DAC) 134. The frequency memory 130 may be implemented to record a frequency of a signal Rx received at the receiver 110 so that the same frequency can used to transmit a signal Tx at the transmitter 112.

In an example, the IC 100 includes a modulator 140 connected to the UPC circuit 120. FIG. 1D is a detailed diagram of an example modulator circuit 140 of FIG. 1. The modulator 140 receives an output data stream 145 from a microcontroller. Signal strength relative to a DAC and amplitude programming bits set the modulation deviation or modulation amplitude. FSK is achieved by shifting to higher frequencies when data stream is high, input to CO goes higher, and by shifting to lower frequencies when data stream goes low, input to CO goes lower. The DAC sets the center frequency, or carrier frequency to demodulate around. The block Rx 112 generates an enable signal Rx which indicates the transceiver is in receive mode when it is asserted, or is in transmit node when de-asserted per this drawing (In practice two enable signals are often used one to set transmit mode and one to set receive mode, thus allowing both to be de-asserted at the same time to turn off all power). The Rx block may use system logic to determine the state of operation for the transceiver, which may or may not be needed as mode signals may come directly from microcontroller. Block 142 is a modulation driver modulating the output clock and determining the modulation amplitude via the CO 124.

In an example, the IC 100 includes a demodulator 150 connected to the UPC circuit 120. FIG. 1E is a detailed diagram of a WBA 152 example in demodulator 150 circuit of FIG. 1. FIG. 1F is a detailed diagram of a Synch 154 example in demodulator 150 circuit of FIG. 1. The demodulator 150 includes a wideband amplifier (WBA) 152, and synchronization circuit 154. The demodulator 150 receives phase coordinated signals from the UPC and amplifies and filters these to create an input data stream, the demodulated data from receiver antenna, and a synchronizing clock signal 155 generated to clock the demodulated data, each clock period conveying a bit a data per the leading edge of the clock.

In an example, the mux 160 receives a mode signal Rx 112, indicating that the transceiver is in receive mode when asserted, thus selecting the output of NBA 114 for input to UPC 120. Otherwise, when Rx 112 is de-asserted, the transceiver is in transmit mode and a crystal-generated clock 162 would then be selected for input to the UPC. The output driver 170 scales up power for transmission and is part of conjugate matching for the transmit antenna Tx 112.

An example of the UPC 120 is disclosed in more detail in related, co-owned U.S. patent application Ser. No. 13/758,915 titled “Phase Coordinating Systems and Methods” of Jed Griffin, filed on Feb. 4, 2013 and incorporated herein by reference in its entirety as though fully set forth herein.

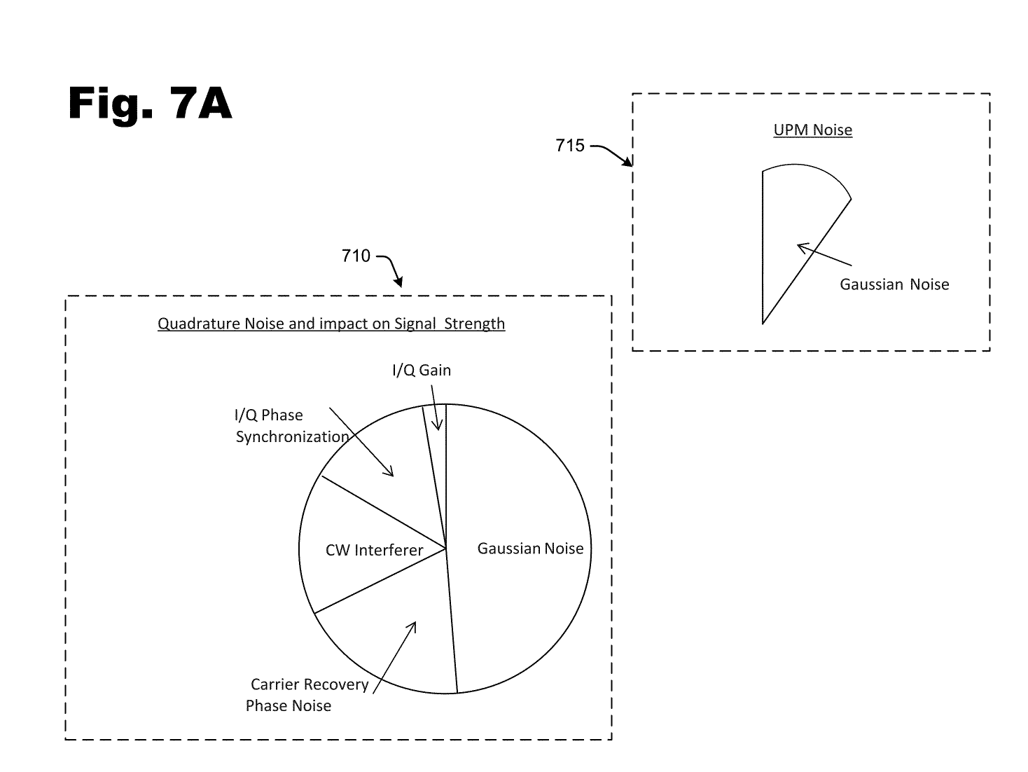

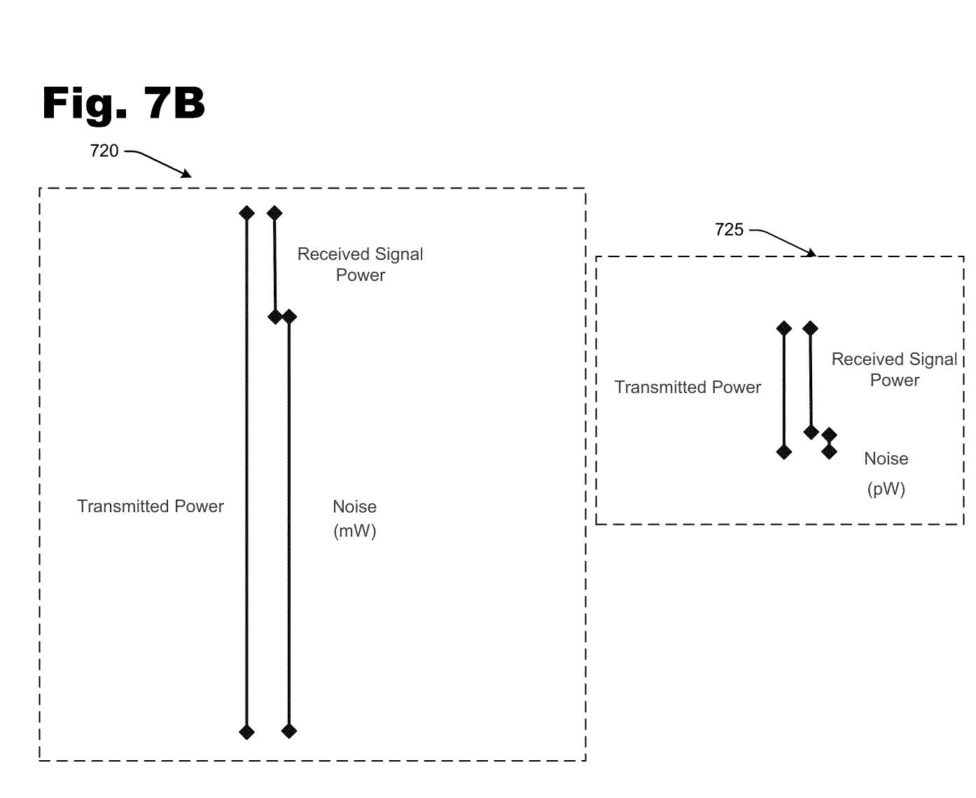

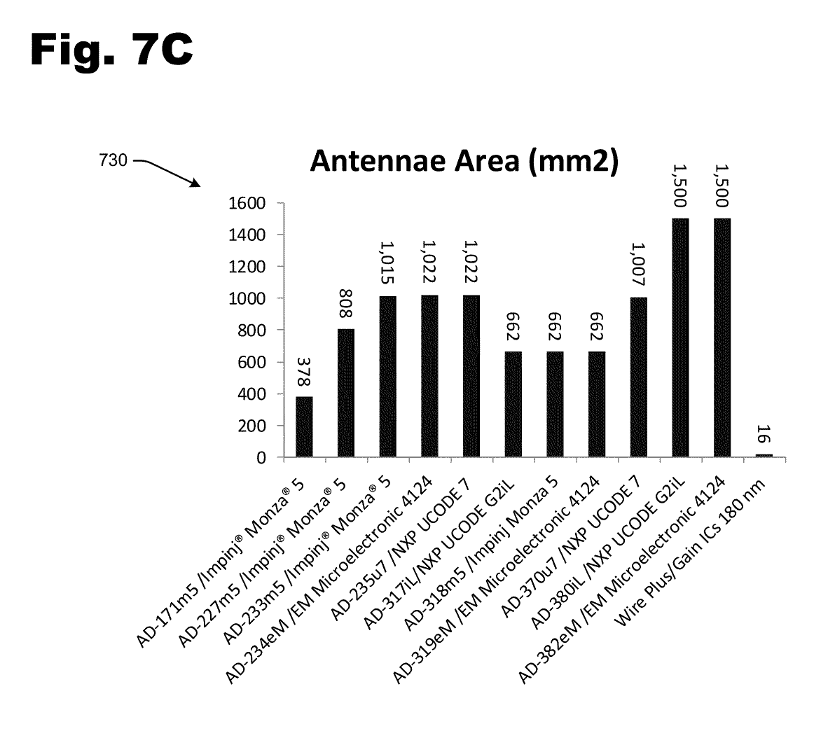

In an example the UPC 120 operates as an ultraphase modulator, by eliminating down-conversion, and reducing demodulation to three operations in a wireless receiver: amplify, filter, and demodulate (all in hardware as shown in FIG. 7 discussed below). By contrast the quadrature architectures include additional and noisy operations, including: amplify, down-convert, synchronize phases, filter, convert to digital (ADC), and then demodulation via DSP (done in software). The UPC 120 may be said to operate as an ideal (or near-ideal) phase locked loop (PLL). As such, the UPC 120 enables wireless performance to leapfrog that of quadrature architectures that are bogged down with inherent limitations and problems owing to their considerable complexity and added noise. These and other aspects of the wireless network throughput system and method disclosed herein will become apparent from the following discussion.

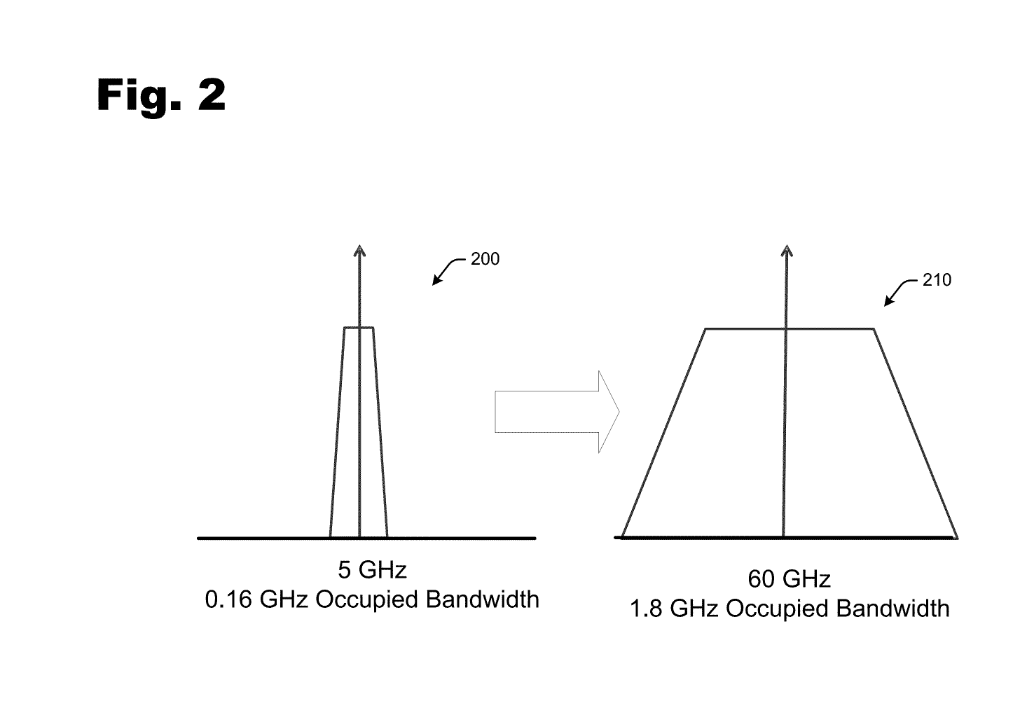

FIG. 2 is a high-level illustration of increasing bandwidth to achieve greater throughput. Even without achieving widespread adoption of IEEE 802.11ac in the market place, a new specification (IEEE 802.11ad) is now being introduced. As shown by contrasting the 5 GHz (0.16 GHz occupied bandwidth) plot 200, with the 60 GHz (1.8 GHz occupied bandwidth) plot 210 (both shown in FIG. 2), it can be seen that more than ten times greater spectral bandwidth is needed to increase throughput according to the 802.11ac and 802.11ad specifications. The radical changes and frequent iterations in specifications are also indicative of the limit on higher throughput and interference from increased frequency spectrum usage that is needed to increase data transfer rates. This in turn limits throughput.

Other wideband techniques, such as direct-sequence spread spectrum (DSSS), also similarly and adversely affect spectrum usage. While lowering power spectral density DSSS impacts even greater ranges of bandwidth, albeit with less concentrated power, but still contributing to the spectrum efficiency problem, adding to channel interference and other frequency crowding issues.

The dominant limitation of quadrature architecture and other software-based demodulation methods lies in channel noise, which is related to the SNR. The additional stages needed to implement such demodulation are themselves additional sources of noise generation and power. As a result, signal strength has to be dramatically increased at the transmitter, increasing power spectral density, to compensate for poor receiver sensitivity due to this inherent and pronounced limitation in quadrature architectures. This has led to a proliferation of solutions attempting to compensate for this inherent limitation, such as DSSS and dynamic spectrum access (DSA).

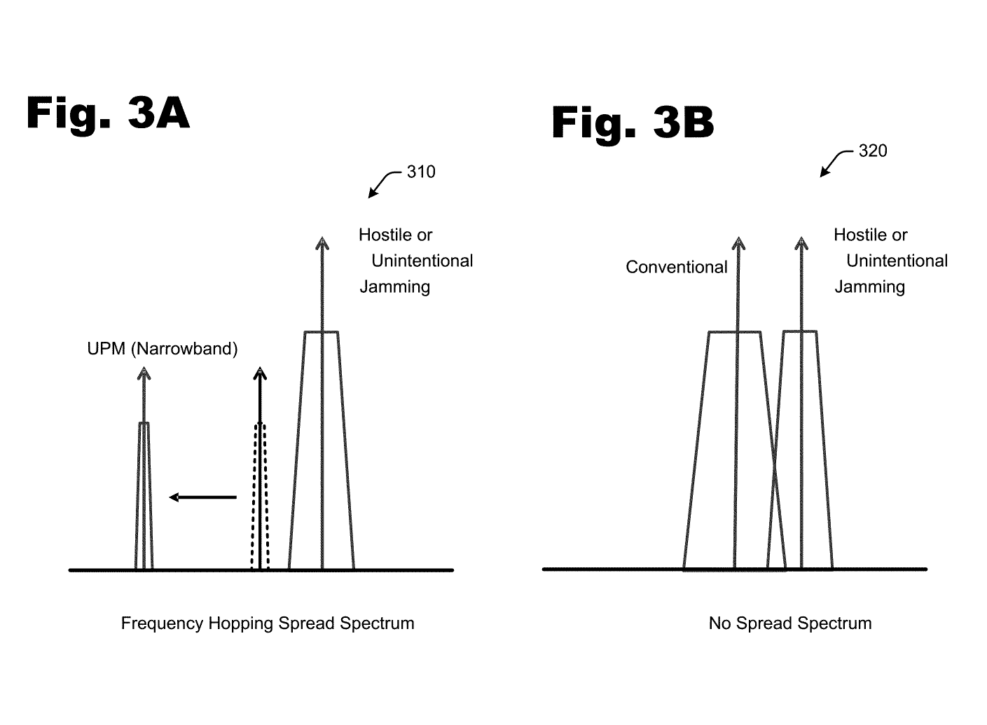

The wireless network throughput system and method disclosed herein, utilizes UPM to increase link spectral efficiency, thus lowering power spectral density, while achieving greater network throughput. UPM provides a more effective solution at lowering power spectral density and eliminating frequency crowding issues (e.g., interference). The UPM approach is depicted relative to the broadband solution with reference to FIGS. 3A-B and 4A-B.

FIGS. 3A-B are high-level illustrations showing how the wireless network throughput system and method eliminate interference of traditional RF communications, wherein A) shows frequency hopping spread spectrum 310, and B) shows typical RF communication with no spread spectrum 320.

Conventional RF communication 320 is severely hampered by frequency crowding, with signal channels often interfering with adjacent channels and causing various disruptions, including dropped links and retransmitted data. UPM 310 alleviates these issues greatly by reducing spectral footprint by 17 times or greater, allowing it to better fit into fragmented spectrum as well as free up 17 additional channels for 17 times more data to be communicated in the same space. It also enables very fast frequency hopping not possible with conventional solutions.

Advantages of UPM relative to conventional RF communication can be seen in FIG. 3. The smaller occupied bandwidth of UPM translates into less interference with adjacent signals, and the ability to fit data into more fragmented slots across the spectrum. In addition, the nanosecond transition time to new frequency enables frequency hopping versus the roughly 500 millisecond times of conventional RF is prohibitive to frequency hopping.

The narrow occupied bandwidth of UPM, in addition to minimizing power spectral density more than RF communications, also offers other advantages. For example, frequency-dependent effects that impact wide bandwidth communications such as DSSS (e.g., distortion, fading, absorption and dispersion), are insignificant as the occupied bandwidth narrows closer to a single frequency. This also enables filters to be tightened without risking inter-symbol interference (ISI). Doppler shifts may also affect the signal roughly the same, because the frequency is concentrated in UPM, with a slightly wider bandpass filter to allow for Doppler shifts. Compare this with the unwieldy shifts seen across wider ranges of frequencies in broadband solutions.

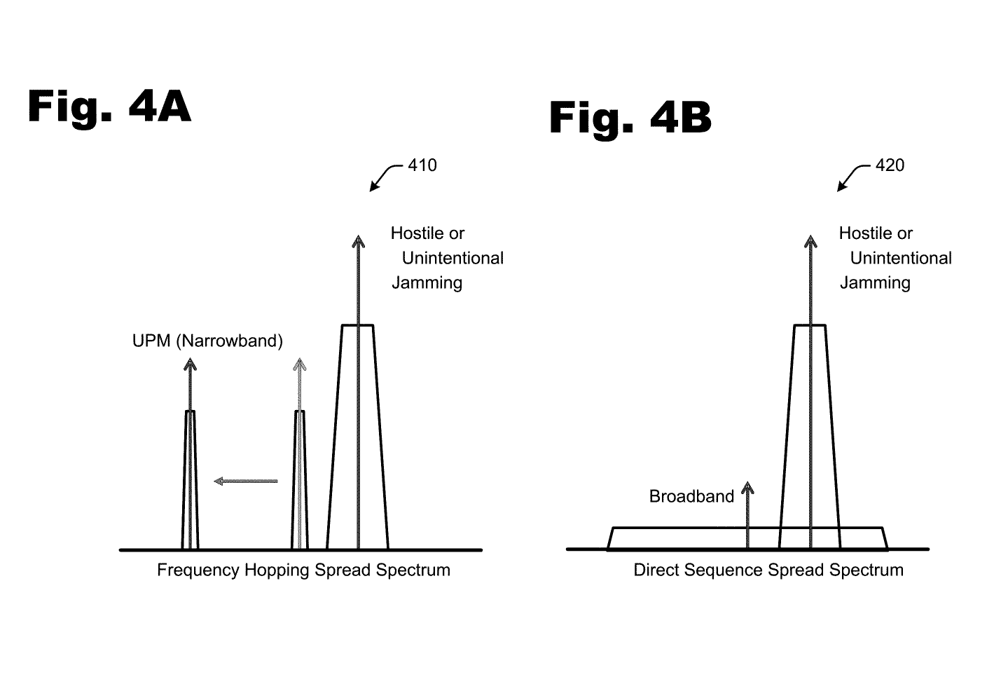

FIGS. 4A-B are high-level illustrations showing narrowband versus broadband, wherein A) shows a frequency hopping spread spectrum 410, and B) shows a direct-sequence spread spectrum 420. It is noted that the power spectral density using UPM can be kept under that of wideband, e.g., by concentrating frequencies to a much smaller occupied bandwidth, thereby increasing link spectral efficiency.

While Direct sequence spread spectrum 420 seeks to alleviate interference in the often contested and congested RF environments, it creates a poor tradeoff of either compromise the strength of your own signal (keeping power spectral density of transmitted signal low across wideband), or adversely impact all other signals transmitting in that same wideband with greater interference to achieve stronger transmitted signal. Other downsides are frequency-dependent effects such as distortion, fading, absorption and dispersion and Doppler Effect. UPM 410 eliminates these compromises by both keeping occupied bandwidth very narrowband and enabling very fast frequency hopping (10,000,000 times faster than typical quadrature architectures) to uncontested and uncongested bands.

Advantages of a narrowband UPM over a broadband DSSS solution include, but are not limited to a lower power spectral density per less complex modulation. UPM offers a much higher receiver sensitivity (lower SNR), allowing less transmit power. UPM also offers more efficient modulation, translating into less occupied bandwidth.

Advantages of a narrowband UPM over a broadband DSSS solution include, but are not limited to no signal fratricide or interference issues. Frequency hopping moves completely away from any interference. Frequency transition times less than 100 ns. UPM is 10,000,000 times faster than typical 500 ms.

Advantages of a narrowband UPM over a broadband DSSS solution include, but are not limited to higher data rate and link spectral efficiency. The link spectral efficiency has been shown to be 17 times greater than latest Wi-Fi specification. UPM has a much higher throughput (e.g., 1 Gb/s for single channel at the mid GHz range). UPM is also scalable with frequency.

In an example, achieving frequency hopping with UPM is a very fast frequency selection, with transition times (turn-around times) in the low nanosecond range, close to real time relative to the typical 500 ms times of quadrature architectures. So while frequency hopping has not been feasible in the past for RF communications requiring fast throughput, given the near real-time transitions of UPM, it is now a superior solution to the other spread spectrum solution that has been commonly used (e.g., DSSS).

UPM also makes frequency hopping not only feasible, but superior. For example, the near real time transition to new frequencies and greatly reduced occupied bandwidth allows the circuit incorporating UPM to fit into many more channels in the already fragmented frequency spectrum.

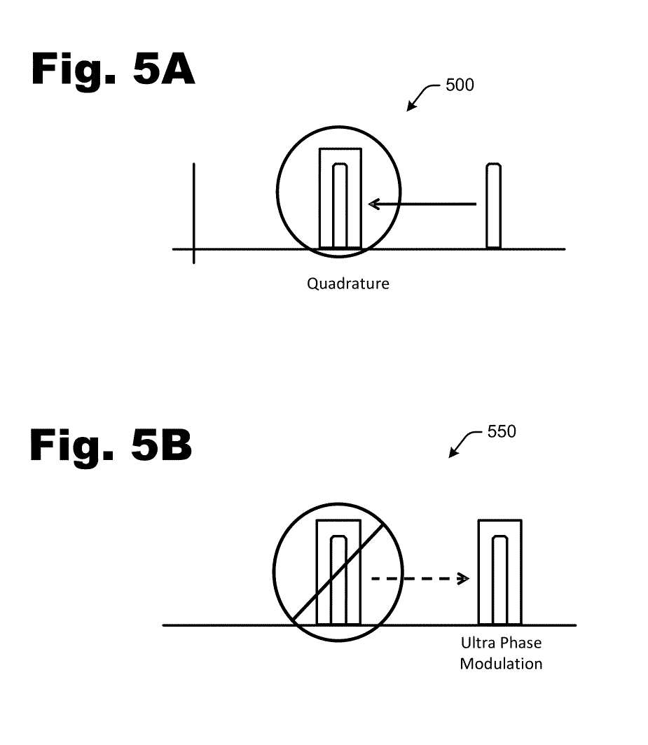

FIGS. 5A-B are plots 500 and 550 showing how the wireless network throughput system and method eliminate down convert. The wireless network throughput system and method is a new wireless technology, UPM (a fast frequency shift keying (FSK) modulation), using ultra phase coordination (UPC), an ideal phase lock loop (PLL). Implementation is far simpler and superior to wireless technologies available today, owing to the elimination of down convert, as illustrated by the comparison of quadrature architectures shown in FIG. 5A with that of UPM shown in FIG. 5B.

It can be seen in FIG. 5A that shift occupied bandwidth to lower frequency to accommodate slower hardware (i.e., the hardware is not fast enough to demodulate at receive frequencies). In addition, superfluous operations are needed, such as frequency shifting, followed by software demodulation. This results in noise folding (which can be worse when amplified), crosstalk, and ADC and DSP noise.

In contrast, FIG. 5B illustrates UPM operating at higher frequencies to demodulate at the received frequency. The hardware is fast enough to avoid having to shift to lower frequencies. As such, only essential operations are needed (i.e., amplify, filter, and demodulate). This eliminates all noise from nonessential operations, and no quadrature phase synchronization is needed.

It can be seen by this comparison, that traditional quadrature architectures 500 can take ten times more circuit area, adding much more noise and power to demodulate than does UPM 550. By streamlining RF reception to three essential operations only, amplify, filter and demodulate, the pronounced and inherent limitations of quadrature architectures are completely overcome.

Enhanced performance of the wireless network throughput system and method is accomplished by the UPM overcoming a limitation of prior PLLs, specifically jitter peaking. Initial data shows that UPM results in a less complicated solution with lower cost, smaller size, and higher receiver sensitivity with a much improved required signal to noise ratio (SNR).

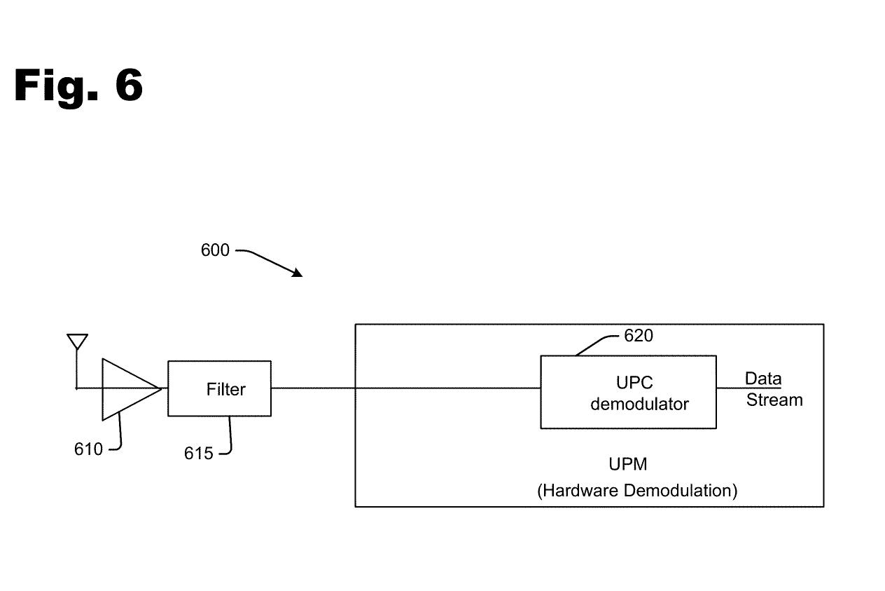

FIG. 6 is a high-level illustration of UPM by the wireless network throughput system. FIG. 6 shows that UPM may be implemented in a circuit 600 with a low noise amplifier (LNA) 610 and a filter 615. The UPC circuit 620 provides UPM demodulation.

It is noted that the circuit 600 does not include the stages of quadrature receivers: carrier recovery PLL, down-convert mixers, quadrature synchronization, analog to digital converter (ADC) and digital signal processing (DSP). All of the corresponding noise, die area and power consumption are also eliminated by the circuit 600.

Notorious channel noise of quadrature architectures prevents these devices from realizing the desired 1 Gb/s or higher per channel data transfer rates. Current devices also require multiple channels for higher throughput, in turn adding crosstalk or greater interference. The poor noise immunity of quadrature architectures require clumsy solutions with multiple channels transmitting simultaneously which in turn presents a whole new set of complexity and noise sources among other problems. Dominant sources of channel noise are shown as they correlate to superfluous operations and additional delay paths in Table 1.

TABLE 1
Comparison of demodulation operations.

| | Quadrature | UPM | |
|---|---|---|---|
| Operation | Architecture | Architecture | Noise |
| Amplify (LNA) | X | X | Device Noise |
| | | | (Thermal) |
| Filter | X | X | Inter Symbol |
| | | | Interference |
| Carrier Recovery | X | | PLL Phase Noise |
| Phase Synchronization | X | | Crosstalk, Device |
| | | | Noise |
| Down-Convert (Mixing) | X | | Noise Folding, |
| | | | Device Noise |
| Convert to Digital (ADC) | X | | Resolution vs. |
| | | | Sample Rate |
| Demodulate in Software | X | | Fast Fourier |
| (DSP) | | | Transform |
| Demodulate in | | X | Device Noise |
| Hardware | | | |

As shown in Table 1, all sources of dominant channel noise prominent in quadrature architectures are able to be eliminated with UPM.

The higher power to overcome the dominant channel noise of quadrature also leads to higher SNR requirement of quadrature receivers. This accounts for the sometimes severely hampered transmission and shortened ranges of current RF transmission. In contrast the circuit 600 eliminates dominant noise and allows more of the transmitted power to go directly to the signal (i.e., due to the much lower SNR).

As a reference, the noise folding from the down convert in a quadrature architecture is much more pronounced than the amplified noise from the LNA depicted 610 in FIG. 6. The down convert is not needed for demodulation, rather, it is merely shifting to frequencies that traditional hardware and software are fast enough to detect. In order for a quadrature architecture to work properly and give the digital circuitry an opportunity to “catch up,” a down converter is used to slow the signal. Slowing the signal while trying to speed it up via denser QAM constellations is counterproductive.

Elimination of the down convert in the circuit 600 lowers the amount of noise that is introduced into the system in addition to increasing overall data transmission speeds, while lowering the amount of occupied bandwidth (and thus providing greater link spectral efficiencies). In this manner, a purely analog UPM solution eliminates the introduction of additional noise, power consumption, complexity, and system delays.

In relation to frequency spectrum usage, UPM creates a communication channel that reduces the amount of occupied bandwidth (e.g., allowing 17 times more channels in the place of one) over what is available today (e.g., the 802.11ac architecture). UPM also enhances the ability to transmit data at a much faster rate, thus greatly improving use of the frequency spectrum as well as offering more channels for ever increasing data transmission needs.

UPM further frees up the amount of available bandwidth and allows for more channels and more users easing system congestion and the potential for interference. This is significant in that it offers a highly effective and innovative solution to the overcrowded frequency spectrum. Frequency spectrum overcrowding currently is under demand to resolve. Therefore, any solution that improves spectrum use, such as UPM, offers a strategic advantage. A disruptive technology such as UPM vastly improves the current situation, while freeing up the bottleneck in data transmission, both increasing throughput while lowering occupied bandwidth.

FIGS. 7A-B show example noise comparisons and FIG. 7C shows example antennae dimensions. The UPC circuit described herein eliminates most of the noise experienced by the quadrature architecture, as can be seen by comparing the pie chart 710 illustrating noise and impact on signal strength of a quadrature design, with the pie chart 715 illustrating little noise for the UPM. This can also be seen by comparing the power requirements and noise of a quadrature design (720 in FIG. 7B) with that of the UPC (725 in FIG. 7B).

In addition, implementing the UPC results in either much smaller antennae dimensions, as shown by the comparison in bar chart 730 in FIG. 7C, or about a ten times greater transmission distance than other circuits having the same antennae per fixed power configuration owing to the greatly reduced noise of UPM.

The UPC architecture is revolutionary in terms of required SNR, transmission distances, enhanced immunity to smart jamming and interference, lower transmit power and less system complexity. An improved SNR also reduces interference while boosting network performance and spectral utilization.

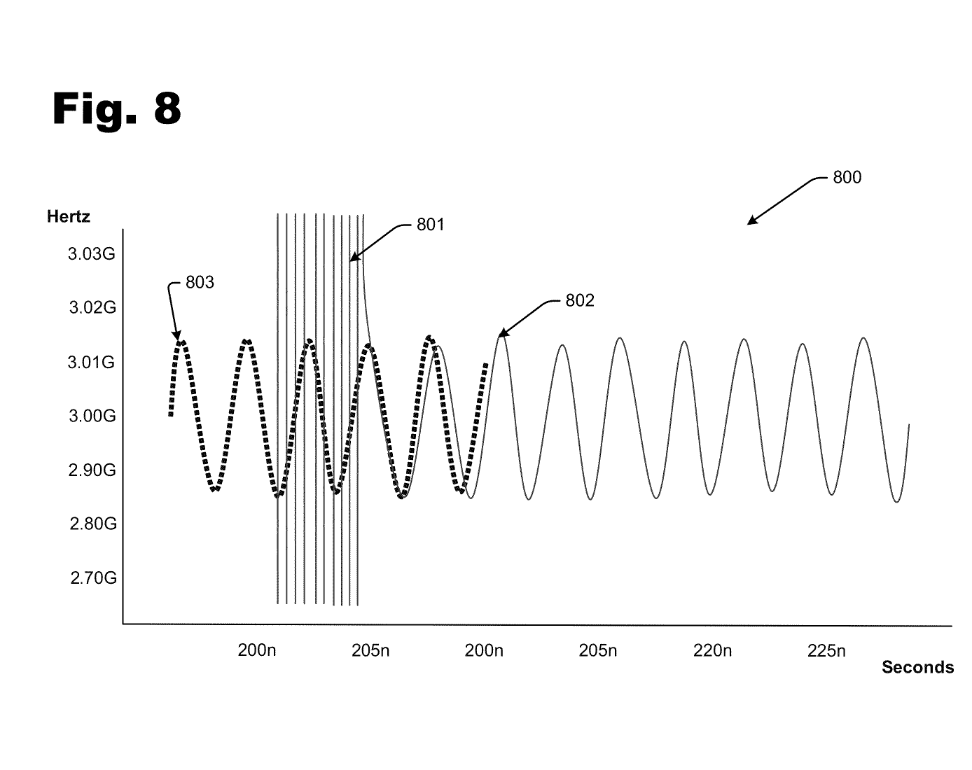

In an example, UPC eliminates jitter peaking, resulting in increased tracking bandwidth that can be utilized for a much simpler and faster demodulation, greatly reducing complexity and eliminating the additional noise sources inherent in quadrature architectures. The UPC also increases overall system stability, while decreasing acquisition/lock time, as can be seen with reference to FIG. 8.

FIG. 8 shows output 800 illustrating high link spectral efficiency, throughput, and faster acquisition time of the wireless network throughput system and method. It can be seen that the input or reference signals (802 representing the demodulated reference signal, and 803 representing the modulated reference signal) and UPC coordinating signal 801 across all voltage, process and temperature variation, that show good correlation under all conditions. That is, the throughput with UPC in a less integrated 55 nm process, 750 Mb/s per channel, is faster than those achieved in practice with quadrature physical links fabricated in more expensive and more integrated processes. The signals in plot 800 are generated while varying voltage process and temperature and show good correlation between the reference phase and coordinating phase in all instances.

In more integrated nodes, UPC crosses the 1 Gb/s per channel threshold. The link spectral efficiency (i.e., a standard measure of spectral efficiency) is observed to be roughly 17 times greater than that of the latest WiFi goals. The occupied bandwidth is 8 MHz versus the latest IEEE 802.11ac specification of 160 MHz, 20 times higher than UPM. The acquisition time, frequency selection and transition times is less than 5 ns across all operating conditions (military temperature range, −55 C to 125 C, and 3-sigma material), or 10,000,000 times faster than typical with traditional PLLs (traditional PLLs are used in quadrature architectures).

It is noted that frequency hopping is very near to real-time, thus making the signal untraceable and more immune to smart jamming. In addition, jamming and interception can be made nearly impossible, as the acquisition times are reduced to a point where the jamming system could lock on, transmit, and shut down (taking only microseconds to complete)—long before a traditional PLL acquires a signal lock (which could take milliseconds).

In addition, UPM provides faster acquisition (transition) time and data transfer (throughput) with much less occupied bandwidth than current methods, thus eliminating vulnerabilities to interference, reduced frequency selection and transition times, while providing the added benefit of reducing jammer susceptibility. The narrower bandwidth of UPM reduce the probability of interference from adjacent channels. In addition, data transfer rates (network throughput) improve along with signal integrity, thus boosting network performance and improving spectral utilization, easing jam ups and expanding the number of channels for users.

The UPC may also be configured to improve spectrum management requirements; transition times to new frequencies are roughly 10,000,000 times faster than the current 500 ms, owing to very low latency and turn-around time of UPM. Current quadrature architectures have transition times in the hundreds of milliseconds versus tens of nanoseconds for UPM.

With lower required SNR, UPM offers both greater receiver sensitivity (1) and much lower bit error rate (BER) (2), as shown by the following two equations:

$$\begin{matrix}{S}^{↑} = ( {kT}_{o} B ) \cdot NF \cdot ( \frac{S}{{N}_{↓}} ) & ( 1 ) \\ {BER}_{↓} = \frac{1}{2} erfc ( {( \frac{S}{{N}_{↓}} )}^{\frac{1}{2}} ) & ( 2 )\end{matrix}$$

While a higher SNR at the receiver may be desired, the required SNR of the receiver needs to be as low as possible to ensure that the transmitted power in a high SNR is not just overcoming noise. UPM realizes very low required SNR, so any desired higher SNR on received signal is indeed signal and not just overcoming noise. At a much lower required SNR, greater receiver sensitivity, the UPM transmits more reliably, at faster throughput and over greater distances.

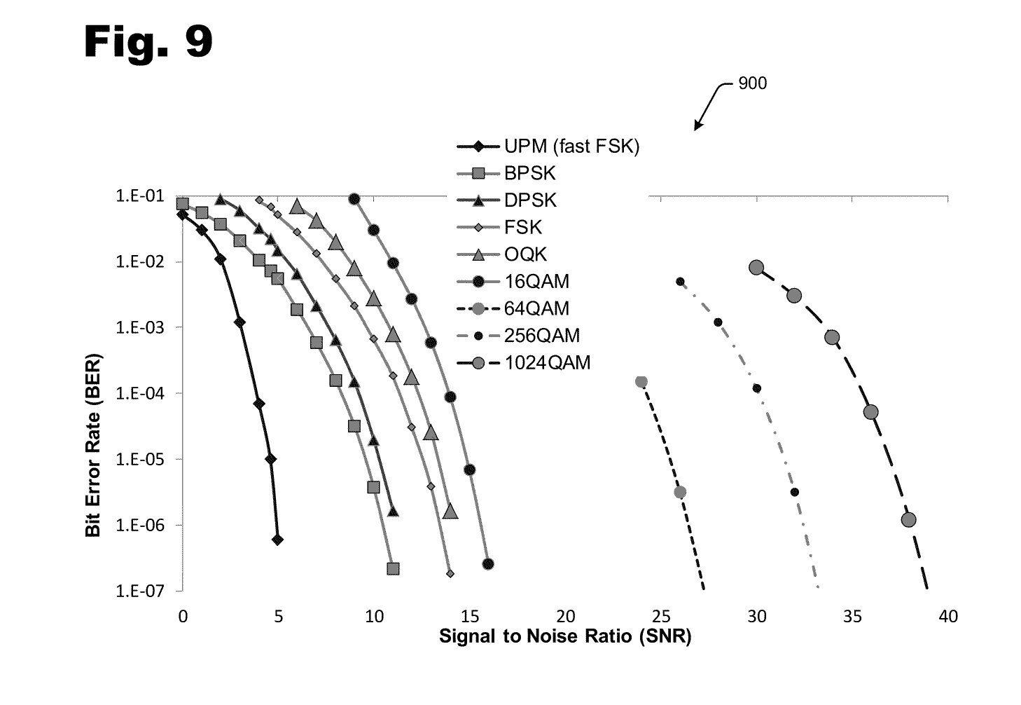

FIG. 9 is a plot 900 showing bit error rate (BER) and signal to noise ratio (SNR) of example modulation methods. BER is a factor in data transmission, as it defines the accuracy of the received data. A poor BER results in missed data that has to be bit checked or resent. This in turn causes much larger latency, additional bandwidth usage, and power consumption, as the system has to check itself for errors. This counterproductive performance, transmitting additional headers and correction bits to also resend unreliably sent bits, only degrades the actual throughput owing to worse BER from poor SNR of current receivers. Thus quadrature architectures do not offer the improved data transfer rates that are often advertised due to having additional “check bits” and other accommodations for a poor noise sensitivity and poor BER.

As shown in FIG. 9, BER (y axis) is directly related to SNR (x axis). Signal integrity is best when BER is low and required SNR is low. A higher SNR of a received signal always enhances performance (e.g., greater transmission distance, improved reliability, etc.). However the lower a SNR required for a receiver to operate, the better the receiver (i.e., the higher the sensitivity of the receiver). UPM has the lowest SNR, and hence offers the best receiver sensitivity. UPM, with faster FSK, may offer clear, concise, and extremely fast data transfer.

With reference to the plot 900 in FIG. 9, the solid curves represent in order from left to right in the Figure, results of the following quadrature-based modulation/demodulation techniques: BPSK, DPSK, FSK, OQK, 16QAM, 64QAM, 256QAM, and 1024QAM. The dashed line on the far left in the Figure represents the results using UPM as disclosed herein. It can be seen that UPM eliminates dominant noise sources and channel noise, and significantly lowers the SNR relative to the other architectures. That is, UPM decreases BER by eliminating channel noise and hence reducing the required signal to noise ratio. A lower required SNR cannot be overemphasized in terms of solving issues plaguing current RF data transfer rates. When compared to 256 QAM, the modulation/demodulation method for 802.11ac Wi-Fi, UPM dramatically reduces required SNR. UPM demonstrates improved spectral efficiency by reducing the occupied bandwidth and increased throughput, and much faster frequency transition time.

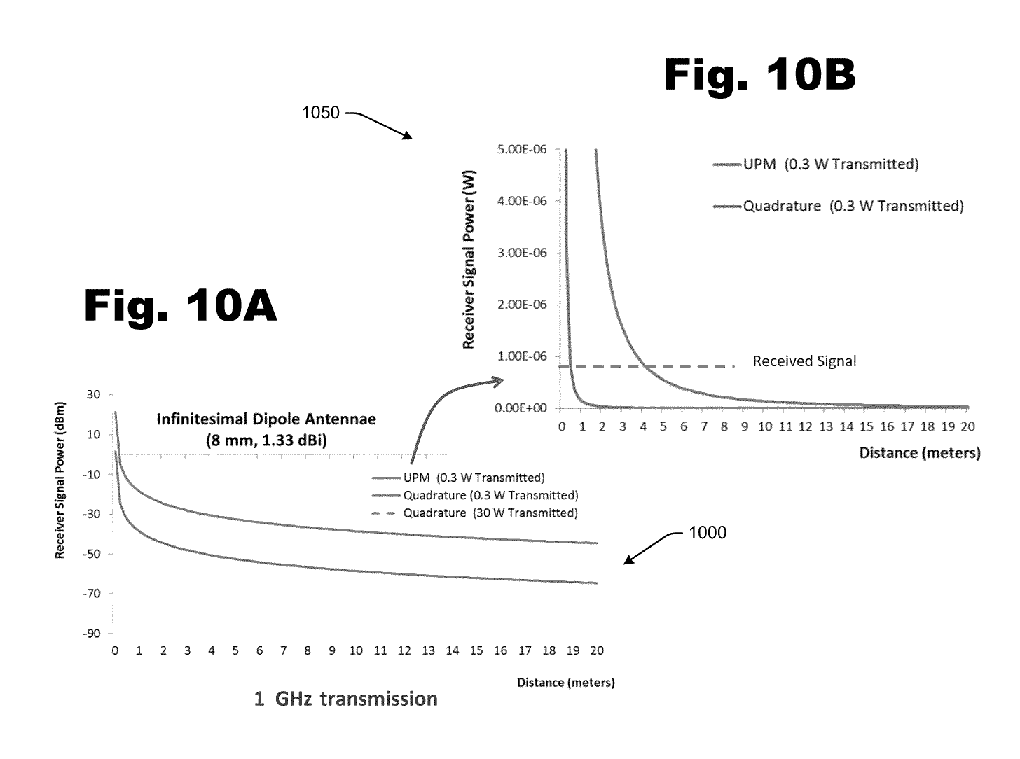

FIGS. 10A-B are plots 1000 and 1050 illustrating transmission distance increase using the wireless network throughput system and method. The standard antennae design and Friis equation shown in FIGS. 10A-B illustrates that the greater receiver sensitivity due to lower SNR also results in greater transmission distances per fixed power and antenna dimensions when using the wireless network throughput system and method. The increase in distance for fixed power spectral density and antenna dimensions is about 10 times greater.

By implementing the wireless network throughput system and method, coordination or tracking bandwidths can be achieved more than 30,000 times faster than traditional PLLs. This enables demodulation that dramatically surpasses quadrature architectures in data transfer rates, spectral link efficiency, and transition time as well as signal strength, integrity, accuracy, and transmission distance.

It is noted that the examples shown and described are provided for purposes of illustration and are not intended to be limiting. Still other examples are also contemplated.

1. A wireless network throughput system, comprising:
a receiver;
a transmitter; and
an ultra-phase coordinator (UPC) circuit connected to the receiver and to the transmitter, the UPC circuit reducing reception to only amplifying, filtering, and demodulating without any down-conversion.

2. The system of claim 1, further comprising a narrowband amplifier (NBA) connected between the receiver and the UPC circuit.

3. The system of claim 1, further comprising a frequency memory, wherein a frequency of a signal Rx received at the receiver is recorded and a same frequency is used to transmit a signal Tx.

4. The system of claim 1, wherein the UPC circuit comprises a phase locator (PL) circuit and a controlled oscillator(CO) circuit.

5. The system of claim 1, further comprising a modulator connected to the UPC circuit.

6. The system of claim 5, wherein the modulator receives an output data stream from a microcontroller.

7. The system of claim 1, further comprising a demodulator connected to the UPC circuit.

8. The system of claim 7, wherein the demodulator includes a wideband amplifier (WBA), wideband amplifier, and synchronization circuit.

9. The system of claim 7, wherein the demodulator receives a coordinating signal from the UPC and generates an input data stream with a synchronizing clock signal.

10. A circuit comprising:
a wireless receiver;
a wireless transmitter; and
an ultra-phase coordinator (UPC) circuit connected to the receiver and to the transmitter, the UPC circuit reducing signal reception and deciphering to only amplifying, filtering, and demodulating without any down-conversion.

11. The circuit of claim 10, further comprising a narrowband amplifier (NBA) connected between the receiver and the UPC circuit.

12. The circuit of claim 10, further comprising a frequency memory, wherein a frequency of an incoming signal Rx at the wireless receiver is recorded and a same frequency is used for transmission of an outgoing signal Tx by the wireless transmitter.

13. The circuit of claim 10, wherein the UPC circuit comprises a phase locator(PL) circuit and a controlled oscillator (CO) circuit.

14. The circuit of claim 10, further comprising a modulator connected to the UPC circuit.

15. The circuit of claim 14, wherein the modulator receives an output data stream from a microcontroller.

16. The circuit of claim 10, further comprising a demodulator connected to the UPC circuit.

17. The circuit of claim 16, wherein the demodulator includes a wideband amplifier (WBA), and synchronization circuit.

18. The circuit of claim 16, wherein the demodulator sends an input data stream with a synchronizing clock signal.

19. A method of handling network throughput, comprising:
providing an ultra-phase coordinator (UPC) circuit;
connecting a receiver antenna to the UPC circuit;
connecting a transmit antenna to the UPC circuit; and
wherein the UPC circuit reduces modulation to only amplifying, filtering, and demodulating without any down-conversion.

20. The method of claim 19, further comprising recording a frequency of the receiving signal Rx and transmitting a transmission signal Tx over the recorded frequency.
